(19) United States
(12) Patent Application Publication
(10) Pub. No.: US 2026/0050286 A1
(43) Pub. Date: Feb. 19, 2026

(54) SKEW CORRECTION CIRCUIT AND METHOD THEREOF

(71) Applicant: MagnaChip Semiconductor, Ltd., Cheongju-si (KR)

(72) Inventors: Ji Un HONG, Cheongju-si (KR); Dong Ho KIM, Cheongju-si (KR)

(73) Assignee: MagnaChip Semiconductor, Ltd., Cheongju-si (KR)

(21) Appl. No.: 19/243,083

(22) Filed: Jun. 19, 2025

(30) Foreign Application Priority Data
Aug. 19, 2024 (KR) 10-2024-0110203

(51) Int. Cl. G06F 1/10

(52) U.S. Cl. CPC G06F 1/10

(57) ABSTRACT

A skew correction circuit includes a skew value detector configured to delay input data and detect a skew correction value for performing skew correction between a data signal and a clock signal, the skew value detector including a first comparator configured to compare the input data with a capture clock signal and detect a Pass or Fail result; and a controller configured to utilize the skew correction value detected.

### CROSS-REFERENCE TO RELATED APPLICATION

This application claims the benefit under 35 U.S.C. § 119 (a) of Korean Patent Application No. 10-2024-0110203 filed on Aug. 19, 2024, in the Korean Intellectual Property Office, the entire disclosure of which is incorporated herein by reference for all purposes.

### BACKGROUND

### 1. Field

The following description relates to a skew compensation circuit and method that allows increasing the operating frequency in Serial Peripheral Interface (SPI) communication.

### 2. Description of Related Art

The interface of a display device or similar device uses a method for high-speed transmission of serial data signals, for example, a Low Voltage Differential Signaling (LVDS) interface (I/F) method.

In high-speed data interface systems, the data signal transmission rate is high, in the unit of gigabits (Giga), and the clock signal and data signal are configured to be transmitted through separate channels. Accordingly, in the transmitting device, the clock signal and data signal are output simultaneously, but in the receiving device, a phase difference between the clock signal and data signal, i.e., skew, may occur. Since the receiving device restores the data signal using the applied clock signal, it may become difficult to restore the data signal if a skew between the clock signal and data signal occurs.

Therefore, correction for skew between the clock signal and data signal may be desired using a skew correction circuit. Furthermore, the skew correction circuit is used to increase the operating frequency in high speed I/F, such as the aforementioned LVDS interface in the gigabit range.

However, in certain devices, such as display modules, there is a problem in which an increase in load capacitance causes a reduction in the maximum operating frequency. Additionally, in SPI communication, increasing the maximum operating frequency requires designing a larger SPI pad size, but if the SPI pad size is enlarged, significant noise is generated.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a skew correction circuit includes a skew value detector configured to delay input data and detect a skew correction value for performing skew correction between a data signal and a clock signal, the skew value detector including a first comparator configured to compare the input data with a capture clock signal and detect a Pass or Fail result; and a controller configured to utilize the skew correction value detected.

The controller may be configured to control transmission of the data signal, after performing the skew correction, using the skew correction value.

The skew value detector may further include a delay component configured to delay the input data by a predetermined delay amount; a first multiplexer configured to select one signal from among an output signal of the delay component and the input data; a shift register including a plurality of flip-flops configured to delay, by a predetermined number of clocks based on a capture clock signal, the output signal of the delay component, which is output from the first multiplexer; and a second multiplexer configured to select one of outputs of the first comparator and output the selected output as a skew correction value.

The controller may be configured to determine whether to delay the input data through the delay component.

The controller may be configured to receive a detection value, indicating the Pass or Fail result, from the first comparator, and determine which detection value the second multiplexer outputs as the skew correction value.

The skew value detector may be configured to detect a second capture data as the skew correction value when the input data and the capture clock signal occur simultaneously in a skew correction mode. The controller may be configured to use the second capture data in a normal operation mode.

The skew value detector may be configured to use a first capture data as the skew correction value when the input data occurs earlier than the capture clock signal in a skew correction mode. The controller may be configured to use the first capture data in a normal operation mode.

The controller may be configured to control a skew correction mode and a normal operation mode.

The controller may be configured to use the detected skew correction value in a normal operation mode for SPI communication.

In another general aspect, a skew correction circuit includes a skew value detector configured to detect a skew correction value for performing skew correction by delaying input data; a Linear Feedback Shift Register (LFSR) configured to output an output signal to be compared with the skew correction value detected; a second comparator configured to compare the skew correction value with the output signal to detect a Pass or Fail result; and a controller configured to receive the Pass or Fail result.

The output signal of the LFSR may be a random data signal.

The controller may be configured to use the Pass result in a normal operation mode for SPI communication.

The skew value detector may include a delay component configured to delay the input data by a predetermined delay amount; a first multiplexer configured to select one signal from an output signal of the delay component and the input data; a shift register including a plurality of flip-flops configured to delay, by a predetermined number of clocks based on a capture clock signal, the output signal of the delay component, which is output from the first multiplexer; a first comparator configured to compare the input data and the capture clock signal to detect a Pass or Fail result; and a second multiplexer configured to select one of outputs of the first comparator and output the selected output as a skew correction value.

In another general aspect, a skew correction method of operating a skew correction circuit including delaying input data; detecting a skew correction value for performing skew correction by comparing the delayed input data with a capture clock signal; and performing a normal operation mode using the detected skew correction value.

The detecting of the skew correction value may include detecting a predetermined n-th capture data as the skew correction value according to an occurrence order between the input data and the capture clock signal.

Upon the input data and the capture clock signal occurring simultaneously, the second capture data may be detected as the skew correction value.

Upon the input data occurring earlier than the capture clock signal, the first capture data may be detected as the skew correction value.

The skew correction method may further include setting a smallest Serial Peripheral Interface (SPI) pad size; performing a skew correction test by comparing the delayed input data with the capture clock signal using the set SPI pad size to detect a skew correction value; and applying a passed skew correction value of the skew correction test to perform SPI communication upon the skew correction test passing.

The skew correction method may further include upon the skew correction value of the skew correction test failing, increasing the SPI pad size and performing the skew correction test again.

Upon the SPI pad size having a largest maximum size, the skew correction value may not being used.

Other features and aspects will be apparent from the following detailed description, the drawings, and the claims.

### BRIEF DESCRIPTION OF THE DRAWINGS

FIG. 1A illustrates a general skew correction circuit.

FIG. 1B is a timing diagram of the skew correction circuit of FIG. 1A.

FIG. 2 is a configuration diagram of a mobile device.

FIG. 3 is a configuration diagram of a display module.

FIG. 4 is a timing diagram for a case in which skew correction is generally performed using a flip-flop.

FIG. 5 is a configuration diagram of a skew correction circuit.

FIG. 6 is a block configuration diagram of the skew value detector of FIG. 5.

FIG. 7 is a timing diagram for explaining a first skew correction method using a skew correction circuit.

FIG. 8 is a timing diagram for explaining a second skew correction method using a skew correction circuit.

FIG. 9 is a configuration diagram of a skew correction circuit according to another embodiment.

FIG. 10 is a timing diagram for explaining a skew correction method using the skew correction circuit of FIG. 9.

FIG. 11 is a flowchart describing the skew correction process according to one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The purpose of the present disclosure is to provide a skew correction circuit and method that allows the operating frequency to be increased even when the load capacitance of a specific device is large.

The present disclosure provides a skew correction circuit and method that enables the application of a small-sized SPI pad, which remains operable even when the maximum operating frequency of the device is high.

The technical problems of the present disclosure are not limited to the technical problems mentioned above, and other unmentioned technical problems can be clearly understood by those skilled in the art from the following description.

Hereinafter, the present disclosure will be described in more detail with reference to the examples shown in the drawings.

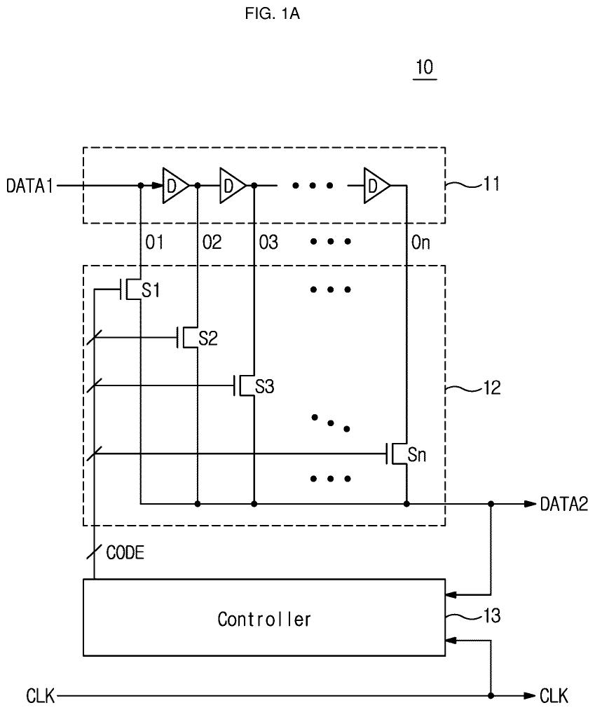

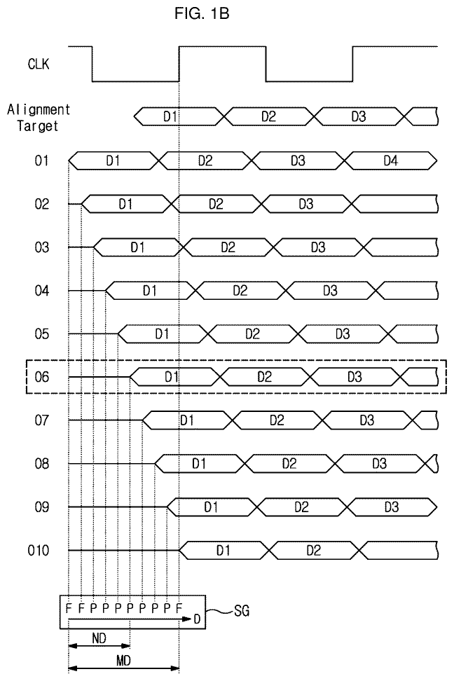

FIG. 1A is a general skew correction circuit, and FIG. 1B is a timing diagram of the general skew correction circuit.

Referring to FIGS. 1A and 1B, a skew correction circuit 10 is configured to include a delay component 11 having a plurality of delay elements D based on input data DATA1 and a plurality of switches (S1˜Sn) 12 capable of selecting the output signals (O1˜On) of the delay component 11.

The skew correction circuit 10 may select one of the plurality of output signals (O1˜On) as output data DATA2. For example, if the rising edge of the clock signal CLK is located at the center of the period of a first bit D1 of the output signals (O1˜On), there is no skew between the corresponding data and the clock signal. Therefore, a controller 13 determines that among the output signals (O1˜On), the output signals O3 to O9, where the first bit (D1) is located at the rising edge of the clock signal (CLK), are considered as passed, and it selects the output signal ‘O6’ with the intermediate delay amount among the output signals included in the pass group as the output data (DATA2).

However, when using the delay component 11, there is a problem of increased load capacitance. Generally, an increase in load capacitance results in a decrease in the maximum operating frequency of the device.

This issue will be further examined by considering cases where delay circuits are applied to a mobile device and a display module, respectively.

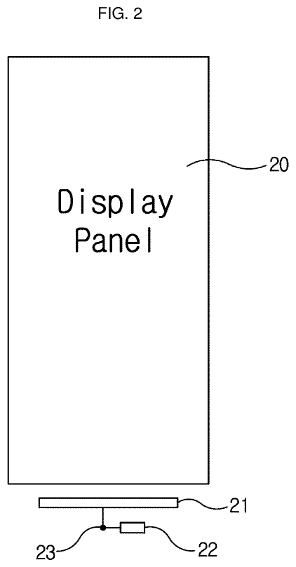

FIG. 2 is a configuration diagram of a mobile device for explaining the present disclosure. The mobile device may, for example, be a cellular phone.

As shown in FIG. 2, the mobile device is configured to include a display panel 20, a Display Driver IC (DDI) 21, and a flash memory 22.

In such a mobile device, it can be seen that the DDI 21 and the flash memory 22 are installed in close proximity to each other due to design constraints. Therefore, the load capacitance (CL) at a point 23 between the DDI 21 and the flash memory 22 in the mobile device, e.g. a cellular phone, generally satisfies the specified specifications of the flash memory 22. In other words, the CL at the point 23 does not exceed the maximum value of the load capacitance, which is 30 pF. As a result, the mobile device may be designed without considering a skew correction circuit.

For reference, Table 1 shows the SPI I/F specifications of the flash memory.

TABLE 1

| | | SPEC | | |
|---|---|---|---|---|
| PARAMETER | SYMBOL | MIN | MAX | UNIT |

| | | | |
|---|---|---|---|
| Load Capacitance | C_{L} | 30 | pF |
| Input Rise and Fall Times | T_{R}, T_{F} | 5 | ns |

| | | | |
|---|---|---|---|
| Input Pulse Voltages | V_{IN} | 0.1 VCC to 0.9 VCC | V |
| Input Timing | IN | 0.3 VCC to 0.7 VCC | V |
| Reference Voltages | | | |
| Output Timing | OUT | 0.5 VCC to 0.5 VCC | V |
| Reference Voltages | | | |

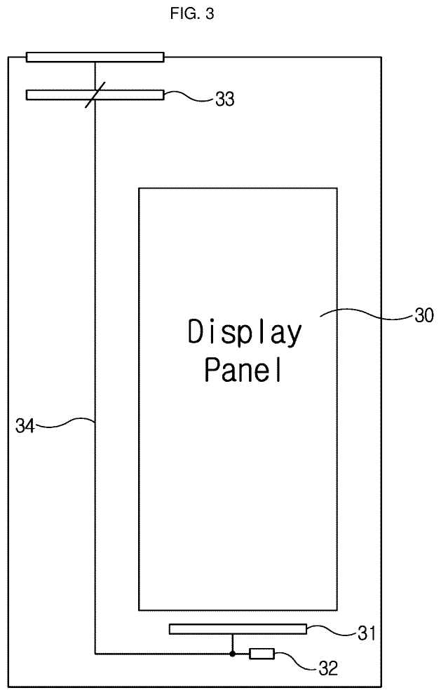

FIG. 3 is a configuration diagram of a display module for explaining the present disclosure.

Display modules undergo a series of test processes before mass production, and in such cases, a display module is further provided with a switch element 33 for controlling a flash memory 32. Thus, the display module includes a display panel 30, a Display Driver IC (DDI) 31 for controlling the display panel 30, the flash memory 32, a signal line 34 for writing correction data to the flash memory 32 from an external jig device provided for testing, and a switch element 33 for performing the test via the signal line 34. Therefore, the display module results in an increased load, and the load capacitance (CL) becomes inevitably much larger than the 30 pF specified in the specifications.

When the load capacitance increases in this manner, the maximum operating frequency, which is determined by the load capacitance, decreases, resulting in a degradation of the display module's performance. Although alternative solutions to increase the operating frequency were considered, the size of the Serial Peripheral Interface (SPI) pad increased, which led to secondary issues such as increased current consumption and noise generation.

In devices such as display modules, in order to perform SPI communication, even when the load capacitance increases as described above, a solution that allows high-speed operation through skew correction may be desired. That is, unlike mobile devices, display modules may desirably include a skew correction circuit.

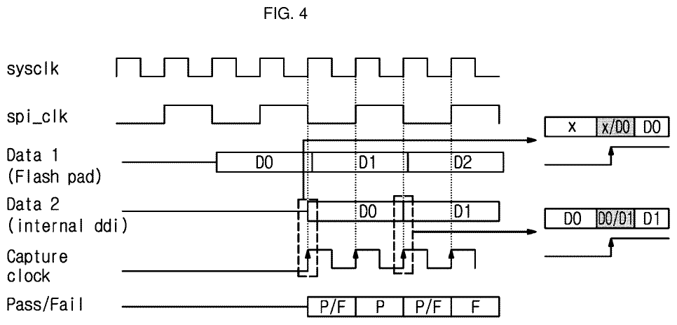

An example of skew correction in a display module may be considered by using logic elements such as flip-flops instead of delay circuits to perform skew correction. However, the following issues when using flip-flops may arise, as depicted in FIG. 4.

FIG. 4 is a timing diagram illustrating a case of performing skew correction using a flip-flop.

Referring to FIG. 4, the timing diagram includes a system clock signal (sysclk), an SPI clock signal (spi_clk), a data signal for a flash memory (Data 1, Flash pad), an internal DDI data signal (Data 2), and a capture clock signal (Capture clock).

As shown in FIG. 4, when a system clock signal (sysclk) is used for internal operation and the system clock signal (sysclk) is divided by 2 to generate an SPI clock signal (spi_clk), up to three pass (Pass) intervals exist where the 0th bit (D0) of the internal data signal (Data 2) is positioned at the rising edge of the capture clock signal (Capture clock). Therefore, it may be difficult to establish a criterion for selecting which of the three pass sections should be used as the skew correction value.

For this reason, there is a possibility that the skew correction circuit may malfunction. Line delay is variable due to jitter, and if the bit of the DDI internal data signal (Data 2) transitions at the capture timing (the rising edge of the capture clock signal), the Pass and Fail results may alternate. In other words, among the three pass sections, the first and third pass sections may operate without error in a skew correction mode and may be used as the skew correction values. However, in a normal operation mode, the pass and fail states alternate, which can cause the skew correction circuit to malfunction. Therefore, even when using flip-flops, there remains an issue where the skew correction may not be performed correctly.

The present disclosure proposes a solution for skew correction that resolves issues associated with the use of flip-flops. The solution proposes a skew correction method that uses both a delay circuit and flip-flops. In skew correction mode, a delay signal is generated to detect a skew correction value, and then, in normal operation mode, the detected skew correction value is used to operate the system.

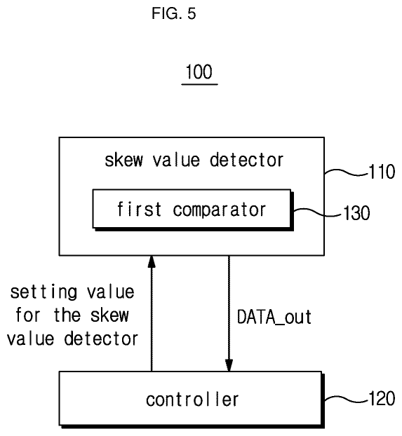

FIG. 5 is a configuration diagram of a skew correction circuit in one embodiment of the present disclosure.

Referring to FIG. 5, a skew correction circuit 100 may include a skew value detector 110, a controller 120, and a first comparator 130. The skew value detector 110 detects a skew correction value (DATA_out) for skew correction, and the controller 120 controls data transmission at high speed after skew correction using the skew correction value (DATA_out).

The controller 120 may control both the skew correction mode and the normal operation mode. The skew correction mode is a mode for detecting the skew correction value (DATA_out), while the normal operation mode is an operational mode in which data is transmitted using the detected skew correction value (DATA_out).

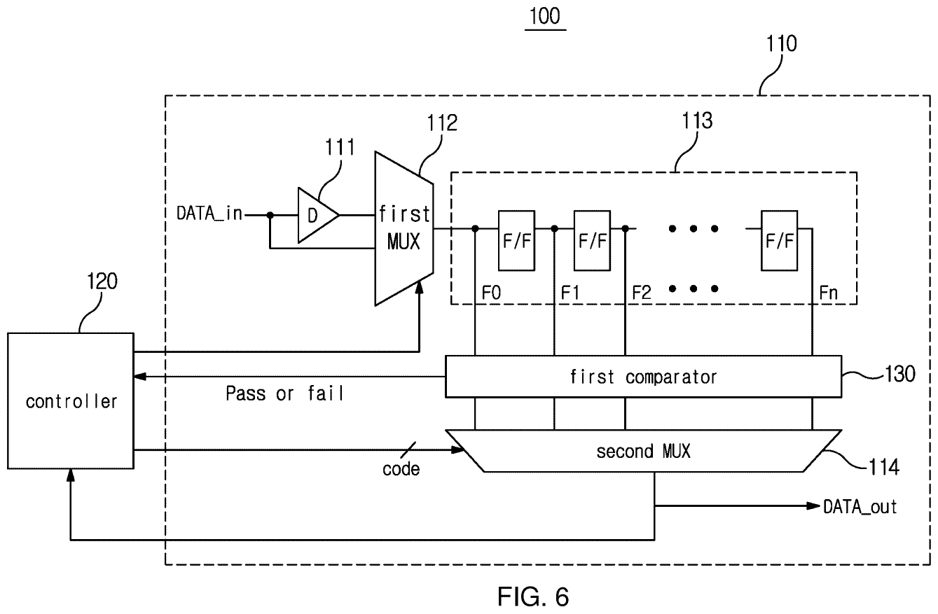

FIG. 6 is a block configuration diagram of the skew value detector in FIG. 5.

Referring to FIG. 6, the skew value detector 110 uses both a delay circuit and flip-flops, and it may be configured to include a delay component 111, a first multiplexer (first MUX) 112, a shift register 113 composed of multiple flip-flops (F/F), a second multiplexer (second MUX) 114, and a first comparator 130.

The delay component 111 may be used in the skew correction mode. The first multiplexer 112 may select either an internal DDI data signal (Data_in) or an output signal of the delay component 111. The shift register 113 is a register that delays by one clock cycle, based on a capture clock signal. In the skew correction mode, the first comparator 130 detects Pass or Fail by using the data (F0 to Fn) output from the shift register 113 based on the capture clock signal. The first comparator 130 may transmit the detected Pass or Fail value to the controller 120. The controller 120 may send a command signal (code) to the second multiplexer 114 to select the capture data that passed at a predetermined n^{th} position among the received Pass or Fail values. Then, the second multiplexer 114 may output the capture data that passed at the predetermined n^{th} position as the skew correction value (DATA_out).

These components may be controlled by the controller 120. The controller 120 may determine whether to delay the internal DDI data signal (Data_in) via the delay component 111. In the skew correction mode, the skew correction value (DATA_out) is determined by using the delayed internal DDI data signal (Data_in) via the delay component 111. In the normal operation mode, skew correction is performed by using the undelayed internal DDI data signal (Data_in) and the detected skew correction value (DATA_out).

Next, a process of performing skew correction will be explained with reference to a timing diagram.

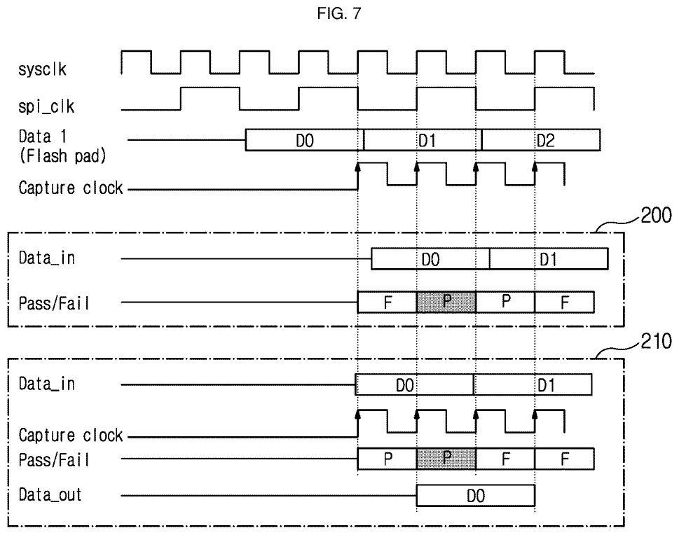

FIG. 7 is a timing diagram illustrating a first skew correction method using the skew correction circuit according to the present disclosure, which describes the skew correction method when an internal data signal of the DDI and a capture clock signal occur simultaneously.

The first skew correction method involves the provision of a system clock signal (sysclk), an SPI clock signal (spi_clk), data signals for flash memory (Data 1, Flash pad), and a capture clock signal (Capture clock), as shown in FIG. 7. This occurs when the internal data signal (Data_in) of the DDI (Display Driver IC) and the capture clock signal (Capture clock) are generated simultaneously.

A controller 120 uses a delay component 111 to find a skew correction value (DATA_out) that can always pass through the capture clock signal. Accordingly, the internal data signal (Data_in) of the DDI is delayed (200) to determine the skew correction value (DATA_out). The determination criterion for a data capture pass (Pass) by the first comparator 130 is met when the 0^{th} bit (D0) of the DDI internal data signal (Data_in) coincides with the rising edge of the capture clock signal. The first comparator 130 determines in skew correction mode 200 that the captured data of a first data section D0 and a second data section D1 of the internal data signal (Data_in) of the DDI results in a Fail (F)-Pass (P)-Pass (P)-Fail (F) sequence, and the controller 120 retrieves this determination result from the first comparator 130.

From the retrieved determination result, the controller 120 detects the second captured data as the skew correction value (DATA_out). While both the second and third captured data are passable, the earlier passed captured data is detected as the skew correction value (DATA_out). Therefore, the controller 120 sends a command (i.e., code) to the second multiplexer 114 to detect the second captured data as the skew correction value (DATA_out), and the second multiplexer 114 outputs the second captured data as the skew correction value (DATA_out) according to the command (code). Since the Pass/Fail determination is made using the delayed internal data signal (Data_in) of the DDI in skew correction mode 200, detecting the earlier passed captured data as the skew correction value (DATA_out) ensures stability.

Once the skew correction value (DATA_out) is detected, the controller 120 may use the detected skew correction value (DATA_out) to transmit data in the normal operation mode. At this time, the controller (120) operates without using the delayed signal, instead utilizing the skew correction value (DATA_out).

In the normal operation mode (210), the first comparator (130) determines that the first and second captured data in the first data section (D0) of the internal data signal (Data_in) of the DDI are each passable (Pass) and that the third and fourth captured data in the second data section (D1) are each failing (Fail). In this case, the first captured data in the pass group may transition to a Fail state because it occurs at the rising edge of the capture clock signal. Therefore, the controller (120) uses the skew correction value (DATA_out) detected in skew correction mode (200) to ensure that data transmission in the normal operation mode relies on the second captured data.

Accordingly, in the normal operation mode following the skew correction mode, the second captured data is used to deliver data within the DDI.

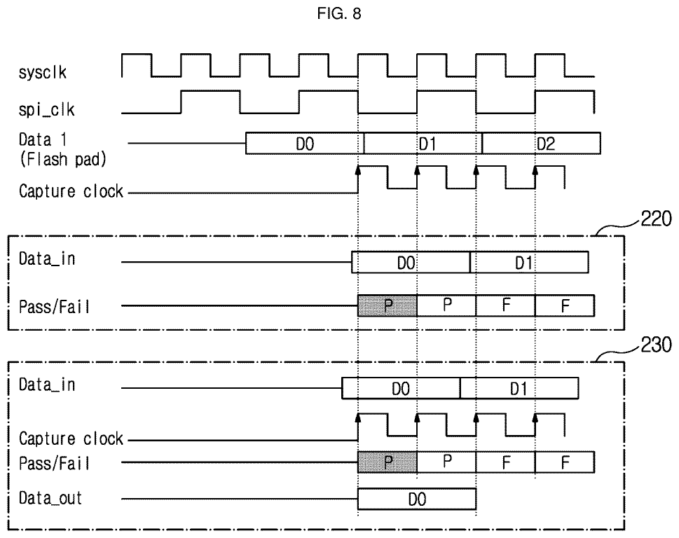

FIG. 8 is a timing diagram illustrating a second skew correction method using a skew correction circuit according to the present disclosure, wherein the skew correction method is applied when an internal data signal (Data_in) of a DDI occurs faster than a capture clock signal (Capture clock).

The second skew correction method is implemented as shown in FIG. 8, where system clock signal (sysclk), SPI clock signal (spi_clk), data signals for flash memory (Data 1, Flash pad), and a capture clock signal (Capture clock) are provided. This method addresses a situation where the internal data signal (Data_in) of the DDI occurs faster than the capture clock signal (Capture clock).

The controller 120 uses a delay component 111 to find a skew correction value (DATA_out) that can always be passed to the capture clock signal. Accordingly, the controller 120 delays the DDI internal data signal (Data_in) (operation 220). The criterion used by the first comparator 130 for determining a data capture Pass is that the 0th bit (D0) of the DDI internal data signal (Data_in) aligns with the rising edge of the capture clock signal (Capture clock). In skew correction mode (operation 220), the first comparator 130 determines that the captured data in the first data interval (D0) and the second data interval (D1) of the DDI internal data signal (Data_in) corresponds to a pattern of Pass (P)-Pass (P)-Fail (F)-Fail (F). The controller 120 retrieves this determination result from the first comparator 130.

Among the results determined above, the controller 120 detects the first capture data as the skew correction value (DATA_out). Both the first capture data and the second capture data are passed, but the earlier passed capture data is detected as the skew correction value (DATA_out). Therefore, the controller 120 transmits a command (code) detecting the first capture data as the skew correction value (DATA_out) to a second multiplexer 114, and the second multiplexer 114 outputs the first capture data as the skew correction value (DATA_out) according to the above command (code). Since the delayed DDI internal data signal (Data_in) is used to judge the pass/fail in the skew correction mode (220), it is more stable to detect the earlier passed capture data as the skew correction value (DATA_out).

Once the skew correction value (DATA_out) is detected, the controller 120 may transmit data in normal operation mode using the detected skew correction value (DATA_out). At this time, the controller 120 operates without using the delay signal and instead operates using the skew correction value (DATA_out).

In normal operation mode (operation 230), the controller 120 uses the first capture data, which is the detected skew correction value (DATA_out). Specifically, in normal operation mode (operation 230), it is determined that the first capture data and second capture data in the first data interval D0 of the DDI internal data signal (Data_in) have each passed, whereas the third capture data and fourth capture data in the second data interval D1 have each failed. Since the DDI internal data signal (Data_in) occurs faster than the rising edge of the capture clock signal (Capture clock), the likelihood of the first capture data failing is low. Thus, in normal operation mode, the controller 120 ensures that data is transmitted using the first capture data, which has been determined to have passed.

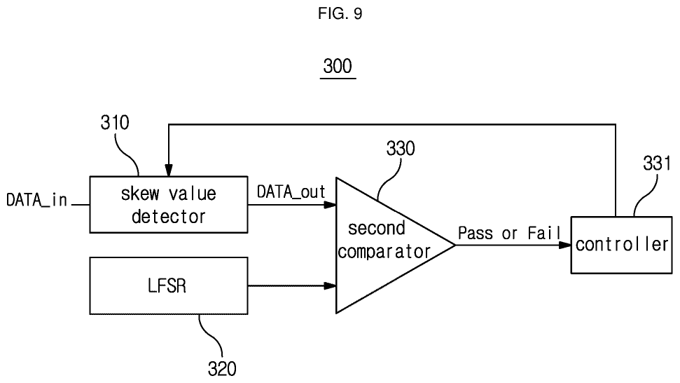

FIG. 9 is a configuration diagram of a skew correction circuit according to another embodiment of the present disclosure.

Referring to FIG. 9, a skew correction circuit 300 may include a skew value detector 310, a Linear Feedback Shift Register (LFSR) 320, a second comparator 330, and a controller 331.

The skew value detector 310 has the same configuration as described in FIG. 6. In other words, it comprises a delay component 111, a first multiplexer 112, a shift register 113, a first comparator 130, and a second multiplexer 114, as in FIG. 6. Through the operation of these components, it outputs a skew correction value (DATA_out).

The LFSR 320 generates a signal to compare with the skew correction value (DATA_out) output by the skew value detector 310. The signal for comparison may be random data. For example, the LFSR 320 may be provided inside a Display Driver IC (DDI) configured to process skew correction by receiving data in a high-speed data interface manner.

The second comparator 330 compares the skew correction value (DATA_out) with the random data signal output by the LFSR 320 to produce a “Pass” or “Fail” result. The controller 331 uses the captured data that the second comparator 330 outputs as “Pass” during normal operation mode.

When the LFSR 320 is included in the skew correction circuit 300 as described, the receiving device within the DDI does not require additional storage space.

Specifically, during skew correction in a high-speed data interface manner, factors such as jitter may cause the timing of data transitions to be inconsistent and variable. This variability may increase the likelihood of misjudging “Pass” and “Fail” outcomes in a specific data interval within the DDI. To address this, the skew correction circuit 300 according to another embodiment of the present disclosure includes the LFSR 320, which increases the number of skew correction operations. The higher the number of skew correction operations, the lower the likelihood of misjudging “Pass” and “Fail” outcomes.

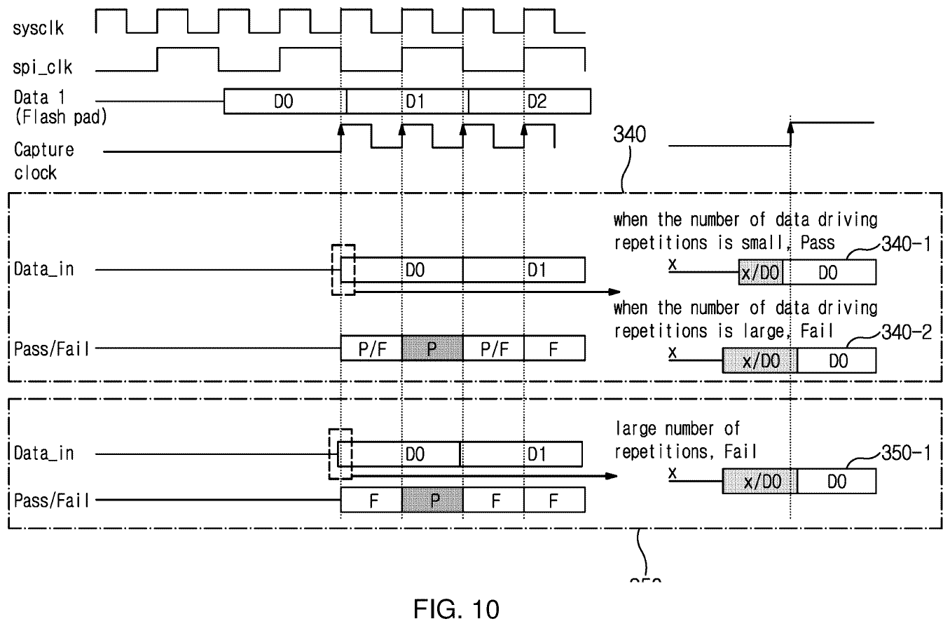

This will be explained further with the timing diagram of FIG. 10.

In FIG. 10, system clock signals (sysclk), SPI clock signals (spi_clk), data signals for flash memory (Data 1, Flash pad), and capture clock signals (Capture clock) are provided, illustrating a case where the internal data signal (Data_in) of the DDI and the capture clock signal (Capture clock) occur almost simultaneously.

In this case, when detecting a skew correction value 340, jitter may cause variations in the timing of data signal reception. If the number of repetitions of data driving in skew correction mode is low, the cumulative number of skew correction operations is also low. Consequently, due to jitter, the rising edge of the capture clock signal (Capture clock) may be included in bit 0 (D0) of the input data. This may result in the first captured data being incorrectly judged as a “Pass” (340-1). On the other hand, by using the LFSR (320) to increase the number of data driving repetitions in skew correction mode, the first captured data is correctly judged as “Fail” (340-2).

Thus, in skew correction mode, the first captured data of the DDI internal data signal (Data_in) is judged as “Fail,” while the second captured data is in a “Pass” state. In normal operation mode (350), a controller 331 uses the “Pass” second captured data for data transmission. The greater the number of repetitions of data driving in skew correction mode, the less impact jitter has during normal operation mode (350). As a result, the first captured data is reliably judged as “Fail” (350-1). If the number of repetitions is low, there is a higher likelihood of incorrectly judging the first captured data as “Pass.”

For this reason, in conventional methods, the number of data-driving repetitions during skew correction was increased as much as desired. However, in this case, since data is stored in the flash memory as desired for skew correction, the size of the flash memory must increase accordingly, and the SPI pad must also increase in physical size.

To address this, if the LFSR 320 is provided inside the DDI as shown in FIG. 9, the second comparator 330 compares the skew correction value (DATA_out) with the output signal of the LFSR 320, and the controller 331 uses the skew correction value determined to have passed according to the comparison result. Thus, there is no need to increase the size of the flash memory and SPI pad.

Meanwhile, in a Serial Peripheral Interface (SPI) communication environment, the smaller the size of the SPI pad, the better, as long as it can provide the desired operating frequency. Accordingly, it is also possible to perform skew adjustment by varying the size of the SPI pad. In other words, by selecting the smallest possible SPI pad that is operational, it is possible to implement a skew adjustment circuit that is robust in terms of noise and capable of providing a satisfactory operating frequency.

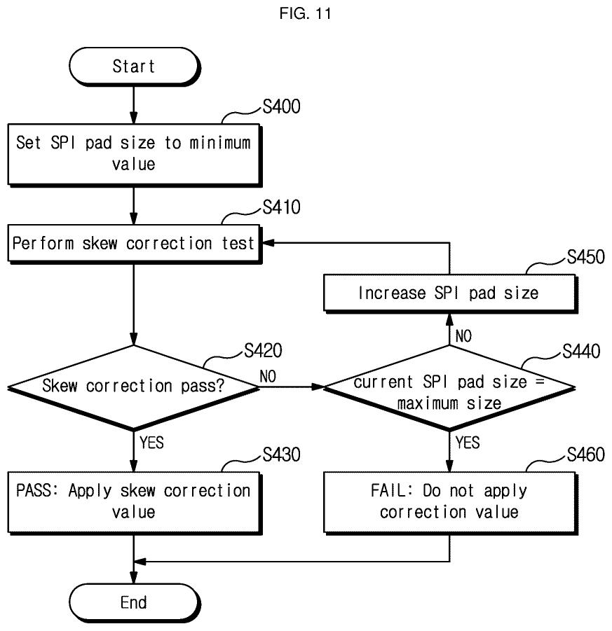

FIG. 11 is a flowchart describing the skew correction process according to another embodiment of the present disclosure.

First, the SPI pad size is set to a minimum value (S400).

Then, a skew correction test is performed (S410). The skew correction test may be conducted using the skew correction methods described above. That is, at least one of a skew correction method using a delay circuit and a flip-flop, and a skew correction method using an LFSR may be employed.

The skew correction result is provided by applying any one of the skew correction methods. If the skew correction passes based on the skew correction result (“YES” in S420), the skew correction value is applied for SPI communication (S430). At this time, the SPI pad retains the initially set size.

If the skew correction fails (“NO” in S420) and the current SPI pad size is not at the maximum size (“NO” in S440), a size larger than the current SPI pad size is selected (S450). Thereafter, the skew correction method is reapplied, and a skew correction test is performed. If the skew correction test passes for the SPI pad with the increased size, the corresponding skew correction value is applied. The increase in SPI pad size may be repeated based on the skew correction test results.

However, if the skew correction test continues to fail and the SPI pad reaches the predetermined maximum size (“YES” in S440), the skew correction value is not applied (S460).

In the above embodiment, only one of the skew correction methods is applied. However, in some cases, both methods may be applied, and the skew correction value may be applied only if both methods pass the skew correction.

According to the present disclosure, even devices with relatively large load capacitances, such as display modules, can generate delayed signals for skew compensation and perform normal operations using the skew-compensated values, thereby improving the maximum operating frequency.

According to the present disclosure, by selecting the smallest SPI pad that can provide the maximum operating frequency for circuit implementation, communication can be performed while solving the noise issues that are relatively vulnerable to the SPI pads.

As described above, the present disclosure uses a delay circuit only during the skew correction operation and utilizes only the skew correction value detected through skew correction during normal operation without using the delay circuit. Accordingly, even if the load capacitance increases during the skew correction of the display module, the operating frequency can be increased. In addition, since the present disclosure uses an LFSR for skew correction, it can accurately detect the skew correction value without expanding the storage space of the flash memory. Furthermore, the present disclosure can select and apply the smallest SPI pad size that provides the optimal operating frequency, enabling SPI communication with high resistance to noise.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A skew correction circuit, comprising:
a skew value detector configured to delay input data and detect a skew correction value for performing skew correction between a data signal and a clock signal, the skew value detector comprising a first comparator configured to compare the input data with a capture clock signal and detect a Pass or Fail result; and
a controller configured to utilize the skew correction value detected.

2. The skew correction circuit of claim 1,
wherein the controller is configured to control transmission of the data signal, after performing the skew correction, using the skew correction value.

3. The skew correction circuit of claim 1,
wherein the skew value detector further comprises:
a delay component configured to delay the input data by a predetermined delay amount;
a first multiplexer configured to select one signal from among an output signal of the delay component and the input data;
a shift register comprising a plurality of flip-flops configured to delay, by a predetermined number of clocks based on a capture clock signal, the output signal of the delay component, which is output from the first multiplexer; and
a second multiplexer configured to select one of outputs of the first comparator and output the selected output as a skew correction value.

4. The skew correction circuit of claim 3,
wherein the controller is configured to determine whether to delay the input data through the delay component.

5. The skew correction circuit of claim 3,
wherein the controller is configured to receive a detection value, indicating the Pass or Fail result, from the first comparator, and determine which detection value the second multiplexer outputs as the skew correction value.

6. The skew correction circuit of claim 1,
wherein the skew value detector is configured to detect a second capture data as the skew correction value when the input data and the capture clock signal occur simultaneously in a skew correction mode, and
wherein the controller is configured to use the second capture data in a normal operation mode.

7. The skew correction circuit of claim 1,
wherein the skew value detector is configured to use a first capture data as the skew correction value when the input data occurs earlier than the capture clock signal in a skew correction mode, and
wherein the controller is configured to use the first capture data in a normal operation mode.

8. The skew correction circuit of claim 1,
wherein the controller is configured to control a skew correction mode and a normal operation mode.

9. The skew correction circuit of claim 1,
wherein the controller is configured to use the detected skew correction value in a normal operation mode for SPI communication.

10. A skew correction circuit, comprising:
a skew value detector configured to detect a skew correction value for performing skew correction by delaying input data;
a Linear Feedback Shift Register (LFSR) configured to output an output signal to be compared with the skew correction value detected;
a second comparator configured to compare the skew correction value with the output signal to detect a Pass or Fail result; and
a controller configured to receive the Pass or Fail result.

11. The skew correction circuit of claim 10,
wherein the output signal of the LFSR is a random data signal.

12. The skew correction circuit of claim 10,
wherein the controller is configured to use the Pass result in a normal operation mode for SPI communication.

13. The skew correction circuit of claim 10,
wherein the skew value detector comprises:
a delay component configured to delay the input data by a predetermined delay amount;
a first multiplexer configured to select one signal from an output signal of the delay component and the input data;
a shift register comprising a plurality of flip-flops configured to delay, by a predetermined number of clocks based on a capture clock signal, the output signal of the delay component, which is output from the first multiplexer;
a first comparator configured to compare the input data and the capture clock signal to detect a Pass or Fail result; and
a second multiplexer configured to select one of outputs of the first comparator and output the selected output as a skew correction value.

14. A skew correction method of operating a skew correction circuit, comprising:
delaying input data;
detecting a skew correction value for performing skew correction by comparing the delayed input data with a capture clock signal; and
performing a normal operation mode using the detected skew correction value.

15. The skew correction method of claim 14,
wherein the detecting of the skew correction value comprises detecting a predetermined n-th capture data as the skew correction value according to an occurrence order between the input data and the capture clock signal.

16. The skew correction method of claim 15,
wherein, upon the input data and the capture clock signal occurring simultaneously, the second capture data is detected as the skew correction value.

17. The skew correction method of claim 15,
wherein, upon the input data occurring earlier than the capture clock signal, the first capture data is detected as the skew correction value.

18. The skew correction method of claim 14, further comprising:
setting a smallest Serial Peripheral Interface (SPI) pad size;
performing a skew correction test by comparing the delayed input data with the capture clock signal using the set SPI pad size to detect a skew correction value; and
applying a passed skew correction value of the skew correction test to perform SPI communication upon the skew correction test passing.

19. The skew correction method of claim of 18, further comprising:
upon the skew correction value of the skew correction test failing, increasing the SPI pad size and performing the skew correction test again.

20. The skew correction method of claim of 18,
wherein, upon the SPI pad size having a largest maximum size, the skew correction value is not being used.
